(19) United States
(12) Patent Application Publication
(10) Pub. No.: US 2008/0077490 A1
(43) Pub. Date: Mar. 27, 2008

(54) METHOD AND SYSTEM FOR MANAGING, UPDATING, AND MONITORING SIGNAGE CONTENT

(76) Inventors: Wayne Wolf, Atlanta, GA (US); Philip Otto, Philadelphia, PA (US); Burak Ozer, North Wales, PA (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/749,530

(22) Filed: May 16, 2007

Related U.S. Application Data
(60) Provisional application No. 60/800,915, filed on May 16, 2006.

(51) Int. Cl. G06Q 30/00

(52) U.S. Cl. 705/14

(57) ABSTRACT

A method and system for updating, monitoring, and managing signage and its related content. A central user may submit content or artwork for display at one or more destination remote sites. The method and system properly format the content of the sign and adapt the content based on the specifications of the destination display. The method and system facilitates the customization of the content to fit the electronic or hard-copy displays located at one or more remote sites.

### CROSS-REFERENCE TO RELATED APPLICATION

This application claims the benefit of U.S. Provisional Patent Application No. 60/800,915, filed May 16, 2006, the contents of which are hereby incorporated by reference herein.

### FIELD OF THE INVENTION

The present invention relates to signage and display systems. Specifically, the present invention relates to a signage management system configured to manage, update, format, customize and monitor the content of signage submitted by a central user for display on or more displays located at a remote site.

### BACKGROUND OF THE INVENTION

Electronic and video displays are widely used for the display of information in a variety of environments, such as stores, airports, hospitals, schools, areas, and other public and private locations. Specifically, airports and airlines made early use of closed-circuit television systems to display flight schedules and other related information. These signage systems include the display and a source configured to delivery the content to be displayed.

More recently, computers and computer networks have been used to provide electronic displays. Computers and computer networks which provide computers have been connected to electronic displays to produce signage. Frequently, disparate hardware and physical displays are used, and as such, the delivery of a fixed format content to a plurality of different displays often results in a mismatch and the display of improperly formatted content.

The lack of centralized control and management over the signage systems forces conventional systems to use simple, universally acceptable formatting which has limited flexibility and is incapable of displaying complex images or streaming images having varying resolution or other characteristics.

However, such systems do not adequately manage sets of displays or content formatted in a non-uniform manner. In addition, conventional signage systems lack any centralized control over the usage of a plurality of displays located at one or more remote sites, and/or the form and format of the content displayed thereon.

### SUMMARY OF THE INVENTION

Embodiments of the present invention relate to a signage management system for managing, controlling, and monitoring signage and content displayed on a plurality of remotely-located displays. The signage management system is able to deliver and customize the format of the content for display on a number of displays having different characteristics. The system allows a content provider to produce content or artwork having a single format, and the system adapts the content for processing and display on each of the plurality of displays in the signage environment.

The signage management system allows a central user to design one piece of artwork (i.e., artwork in a single format) and have it adapted for display at the one or more remote sites. The remote sites may include many different displays having different characteristics, and the signage management system is configured to adapt, convert, and/or customize the artwork so that is may be delivered and displayed by each of the remote displays.

In addition, the signage management system allows the remote user to monitor the status of the one or more electronic displays maintained at their remote site. Furthermore, according to an embodiment of the present invention, the signage management system may allow a remote user (located locally relative to a remote site) to initiate and/or perform limited modifications to the content of the signs (e.g., the addition of certain words to the artwork), wherein the modifications are monitored, tracked, and/or implemented by the central user and/or the signage management system.

According to an embodiment of the present invention, the signage management system may comprise an artwork preparation subsystem, an artwork distribution system, and a site database. The signage management system may be configured to accept artwork deployment requests from a user, and, in response, generate and transmit one or more signage commands to a remote user or display.

The signage management system is configured to customize the artwork based on the specific requirements of each display. According to an embodiment of the present invention, a signage management system is configured to receive a request from a central user for the display of one or more pieces of artwork at or on one or more displays at a remote site, consult a remote site database to retrieve information related to the requested display or displays, prepare a custom version or versions of the artwork, and communicate the artwork via a signage command to the one or more remote sites. According to an embodiment of the present invention, the signage command may cause an electronic display to display the custom artwork. According to an embodiment of the present invention, the signage command may cause a copy of the custom artwork to be printed and/or display in a hard-copy format.

According to an embodiment of the present invention, the remote site database may be a computer-accessible memory storing data associated with the one or more remote sites that are communicatively connected thereto. The remote site database includes remote-site-specific data that includes, but is not limited to, the type of display maintained at the remote site (e.g., electronic or hard-copy-based displays) and the acceptable format(s) that may be processed and accepted by the one or more displays of the remote site.

### BRIEF DESCRIPTION OF THE DRAWINGS

The present invention will be more readily understood from the detailed description of the preferred embodiment(s) presented below considered in conjunction with the attached drawings, of which:

FIG. 1 is an illustration of a signage environment including a signage management system, according to an embodiment of the present invention;

FIG. 2 provides exemplary steps involved in a signage management method, according to an embodiment of the present invention;

FIG. 3 illustrates an exemplary communicative connection between a central site and one or more remote sites of a signage management environment, according to an embodiment of the present invention;

FIG. 4 depicts an exemplary signage management system, according to an embodiment of the present invention;

FIG. 5 illustrates an exemplary remote site, according to an embodiment of the invention;

FIG. 6 illustrates an exemplary artwork deployment request, according to an embodiment of the present invention;

FIG. 7 illustrates an exemplary remote site record stored by a remote site database, according to an embodiment of the present invention;

FIG. 8 depicts a flowchart of exemplary artwork processing steps performed by a remote site, according to an embodiment of the present invention; and

FIG. 9 depicts exemplary steps in processing and executing a customization request, according to an embodiment of the present invention;

It is to be understood that the attached drawings are for the purpose of illustrating concepts of the present invention and may not be to scale.

### DETAILED DESCRIPTION OF THE INVENTION

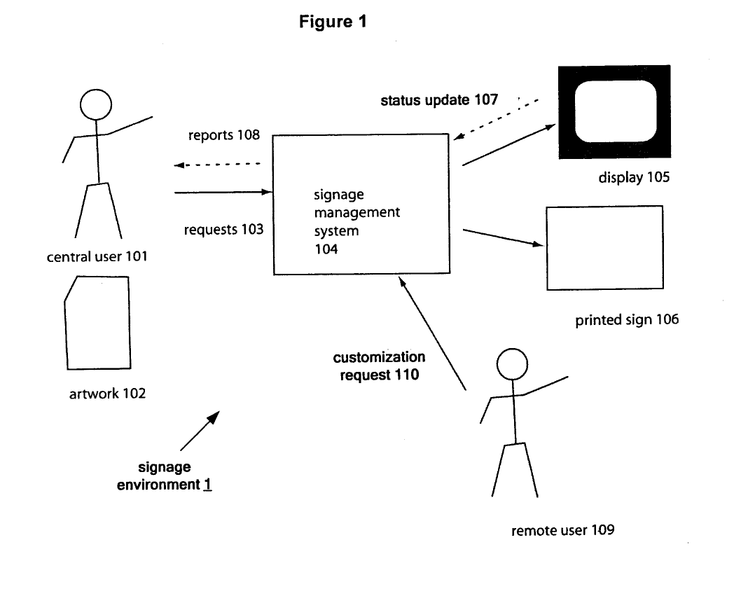

The present invention relates to a system and a method for managing a signage environment. FIG. 1 depicts an exemplary signage environment 1 managed by the methods and systems of the present invention. The signage environment 1 including one or more signage content or artwork sources, herein referred to as a central user 101, communicatively connected to a system for managing and monitoring the signage environment 1, herein referred to as the signage management system 104.

The term “communicatively connected” is intended to include any type of connection, whether wired or wireless, in which data may be communicated. The term “communicatively connected” is intended to include a connection between devices and/or programs within a single computer or between devices and/or programs on separate computers.

The central user 101 is an authorized user responsible for deploying content for display, and may access the Signage Management System 104 using a computer that includes a web browser that provides a portal to one or more Web-based networks, such as for example the Internet. One having ordinary skill in the art will appreciate that many Web browsers, are as known to those of skill in the art, are suitable for use with embodiments of the present invention.

The signage environment 1 further includes one or more remote sites communicatively connected to the signage management system 104. Each remote site includes one more displays adapted to display the content or artwork delivered by the central user 101 via the signage management system 104.

The content of the signage, herein referred to as the “artwork” 102 may include, but is not limited to, a still or moving image arranged in any suitable computer-readable format, such as, for example, a vector file, a pixel file, or animation files, etc. The artwork 102 may be prepared in a number of different styles and formats. Each format has its own advantages and may be suitable for a given task or set of work conditions. In general, those formats must be converted to be displayed on an electronic display or to be printed. Three exemplary styles of artwork 102 are vector (lines, curves, shapes), polygon (often used in computer graphics), and raster (pixels). According to an embodiment of the present invention, the signage management system 104 may convert the artwork 102 into an appropriate format accepted by one or more displays of the remote sites. Exemplary formats for the artwork 102 include, but are not limited to, JPEG, GIF, TIFF, PDF, MPEG, Illustrator, Flash, H.26x, motion JPEG, .WAV, .MP3, various layers of MPEG audio, MIDI, and PS.

The signage management system 104 is a computer-based system configured to receive, manage, and process the artwork 102 received from one or more central users 101 and communicate the artwork 102 to the one or more remote sites for display. The term “computer” is intended to include any data processing device, such as a desktop computer, a laptop computer, a mainframe computer, a personal digital assistant, a server, or any other device able to process data. It is to be understood that the schematic representations of the signage environment 1 and Signage Management System 104 provided in FIG. 1 are exemplary in nature and alternative arrangements are within the scope of embodiments of the present invention. One having ordinary skill in the art will appreciate that the components of the Signage Management System 1 may be located on a single computer or on more than one computer.

The remote sites include, but are not limited to, one or more displays. The displays maintained by the remote sites are managed and controlled by the signage management system 104. The remote displays may be electronic displays 105 and/or displays adapted for hard-copy materials (e.g., a poster), herein referred as printed sign display 106. An electronic display 105 may include, but is not limited to, any display whose content may be controlled and presented electronically, such as, for example, a cathode ray tube, a liquid crystal display, a light emitting diode display, a plasma display, etc. One having ordinary skill in the art will appreciate that these displays, while described as “remote” relative to the central user 101, may in fact be physically proximate to the central user 101, but, are generally located at a substantial physical distance from the central user 101.

The remote sites may be managed by a user located locally relative to the remote site, referred to as the remote user 109. The remote user 109, such as, for example, an individual employed by the remote site, may have limited authority and control over the remote displays.

According to an embodiment of the present invention, the central user 101 sends one or more artwork deployment requests 103 including a computer-generated or computer-readable representation of the artwork 102 and/or instructions for the deployment of the artwork 102, as shown in FIG. 1. The artwork deployment request 103 (also referred to in the Figures as “request 103”) may further include, but is not limited to, the following information: 1) the one or more destination remote sites and/or displays to which the artwork 102 is to be delivered; 2) level of customization permitted; 3) data related to the artwork 102, including but not limited to, the artwork type (i.e., hard-copy or electronic), the format of the artwork (e.g., JPEG, GIF, TIFF, PDF, MPEG, Illustrator, Flash, H.26x, motion JPEG, .WAV, .MP3, various layers of MPEG audio, MIDI, and PS, etc.), the file size (if electronic), the period of time the artwork is to be displayed, etc.; and 4) a request for one or more reports related to artwork deployment.

The electronic display 105 and/or printed sign display 106 may communicate information to the signage management system 104 regarding status, referred to as status updates 107. These status updates 107 may alert the signage management system 104 as to the current state of all or any subset of the displays managed by the system, such as, for example, the artwork currently being displayed), maintenance information, and other display information. The other display information may include, but is not limited to, the technical specifications of the electronic display 105 and/or the date and time of the last update of the display. The status updates 107 may be specifically requested by the central or remote user or may be generated automatically by the signage management system 104, for example according to a set schedule (i.e., daily, weekly, monthly, etc.).

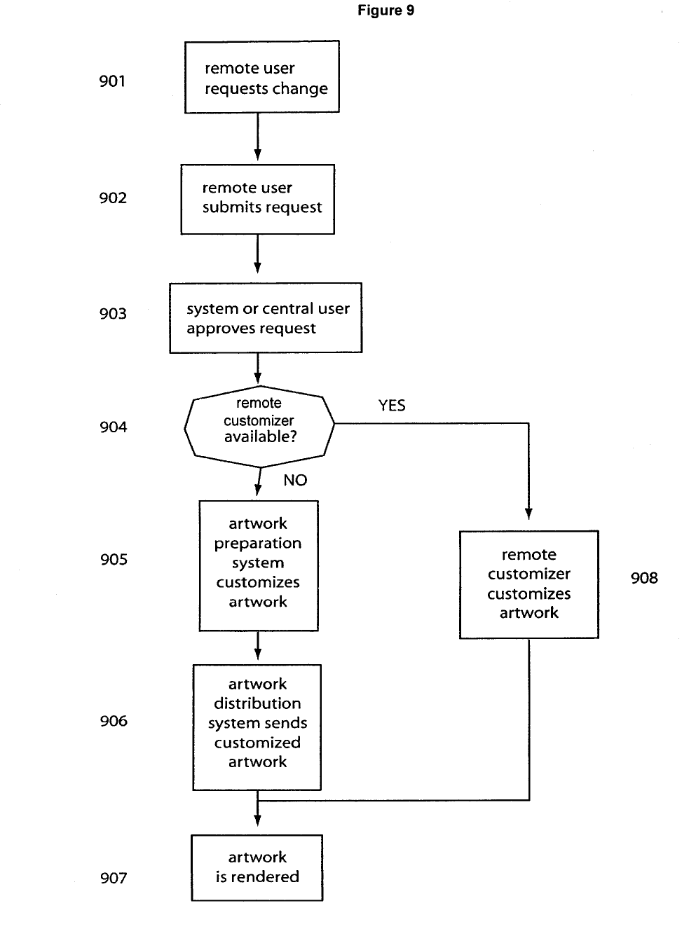

The remote user 109 may submit one or more customization requests 110 to the signage management system 104 and/or the central user 101. The customization request 110 may call for the customization of any aspect of the artwork, such as, for example, the content of the artwork, the type of the artwork (e.g., electronic or hard-copy), the format of the artwork (e.g., JPEG, GIF, TIFF, PDF, MPEG, Illustrator, Flash, H.26x, motion JPEG, .WAV, .MP3, various layers of MPEG audio, MIDI, PS, etc.), the size of the artwork (i.e., the physical size of the hard-copy artwork or the file size of electronic artwork), the display period of the artwork (i.e., the time frame the artwork is to be displayed such as, for example, one day, one week, one month, etc.). An exemplary method for processing the customization request 110 is described below in conjunction with FIG. 9.

The signage management system 104 may use the status 107 information to prepare and provide reports 108 to the central user 101. As discussed above, the reports 108 and information contained therein may be requested by the central user 101 as part of the artwork deployment request 103.

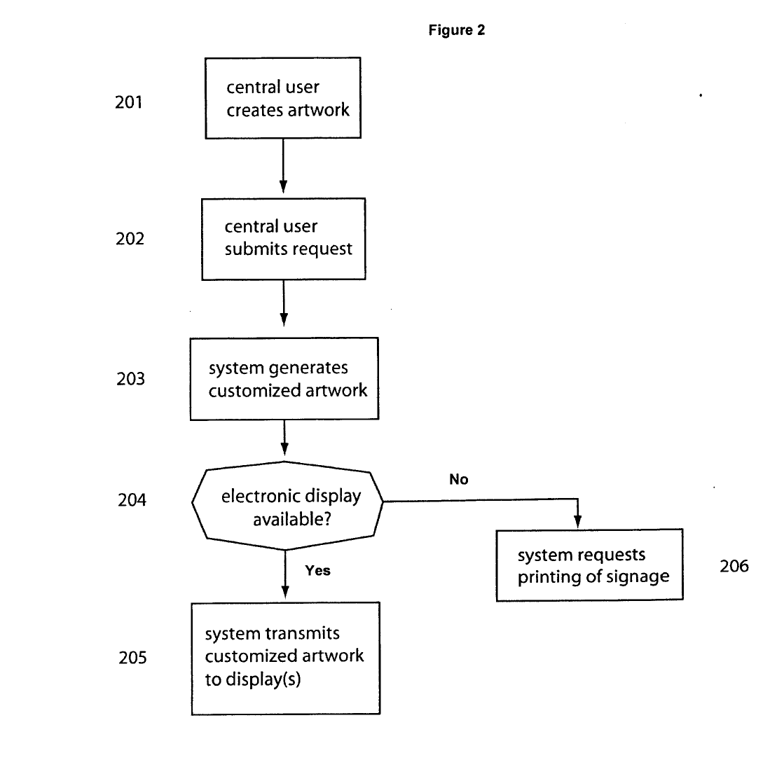

FIG. 2 illustrates an exemplary process flow for processing an artwork deployment request 103, according to an embodiment of the present invention. In step 201, the central user 101 prepares artwork 102 using any suitable technique known in the art. In step 202, the central user 101 submits a computer-generated representation of the artwork 102 to the signage management system 104 via an artwork deployment request 103.

The signage management system 104 receives the artwork deployment request 103, reviews the artwork deployment request 103, and determines the appropriate format of the artwork 102 to suit the characteristics of the selected displays. The signage management system 104 configures the artwork 102 in the appropriate format or formats, making any necessary customizations, modifications, or changes, to the artwork 102, in step 203.

According to an embodiment of the present invention, the signage management system 104 determines whether the destination for the artwork is an electronic display 105, in step 204). If so, the signage management system 104 sends the artwork 102 in an appropriate format to the requested electronic display(s) 105, in step 205. In the event the remote site includes one or more non-electronic or printed sign display(s) 106, the signage management system 104 initiates the delivery and provision of a hard-copy sign for manual installation in the printed sign display 106, in step 206. Upon delivery of the artwork 102 to the one or more remote displays, the signage management system 104 may receive a status update 107 from the remote user 109 and/or one or more displays 105, 106, and may provide a report 108 to the central user 101 including, at least in part, the status update information.

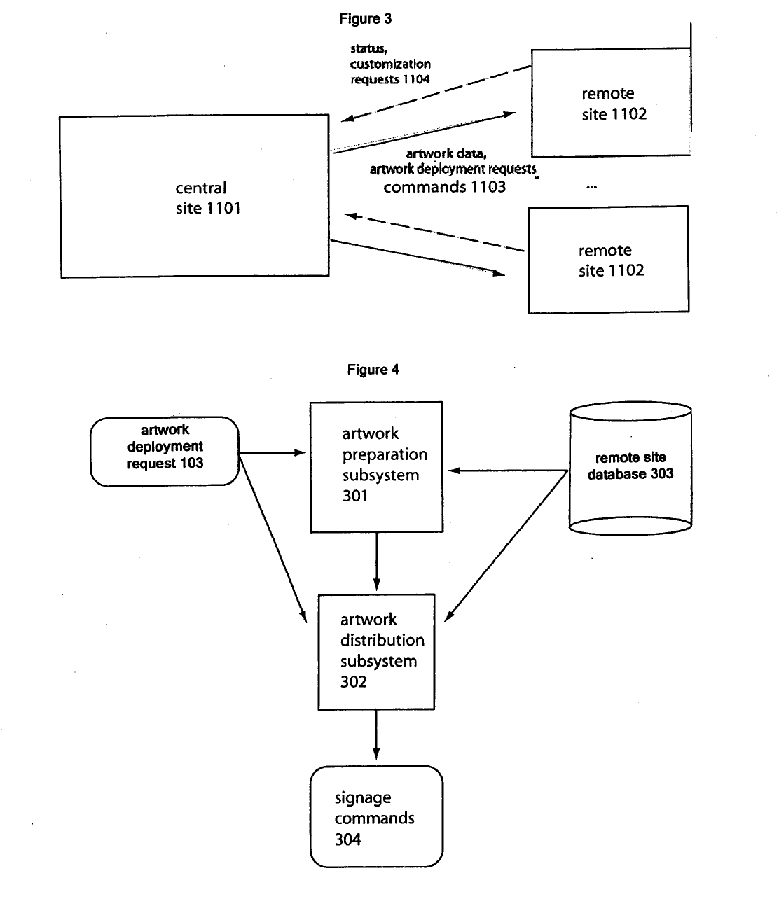

FIG. 3 illustrates an exemplary communicative connection between a central user 101, operating from a central site 1101, and a plurality of remote sites 1102. According to an embodiment of the present invention, the central site 1101 is a computer-based and or human-based system configured to design artwork 102 and issue artwork deployment requests 103. One having ordinary skill in the art will appreciate that while the central sites 1101 and remote sites 1102 are logically distinct, the remote sites 1102 may be physically located at or near the central site 1101. For example, a remote site 1102 may be located in the same room or building as the central user 102. The artwork deployment requests, the artwork data, and commands or instructions regarding deployment, collectively labeled as 1103 in FIG. 3, may be transmitted from the central site 1101 to the remote sites 1102, while status 107 and customization reports 1104 flow from the remote sites 1102 to the central site 1101.

FIG. 4 illustrates an exemplary signage management system 104 according to the present invention. The signage management system 104 comprises an artwork preparation subsystem 301, an artwork distribution subsystem 302. The signage management system 104 further includes, or is communicatively connected to a remote site database 303.

The artwork preparation subsystem 301 is a computer-executable program or module configured to receive and manage artwork deployment requests 103 submitted by a central user 101. The artwork preparation subsystem 301 reviews the artwork deployment request 103 and identifies the one or more destination remote sites and displays to which the artwork is to be delivered. The artwork preparation subsystem 301 is communicatively connected to the remote site database 303, which is a computer-accessible memory that stores information related to the one or more remote sites 1102, referred to as remote site records. Each remote site record includes, but is not limited to, information related to the one or more displays located at the remote site, such as, for example, the type of display (i.e., electronic or hard-copy), the number of displays located at the remote site, the make and model of the display, the size of the display, one or more suitable formats accepted by the display, the storage capacity of the display, other relevant characteristics of the displays, etc. The artwork preparation subsystem 301 uses the remote site record to prepare, adapt, and/or customize the artwork accordingly.

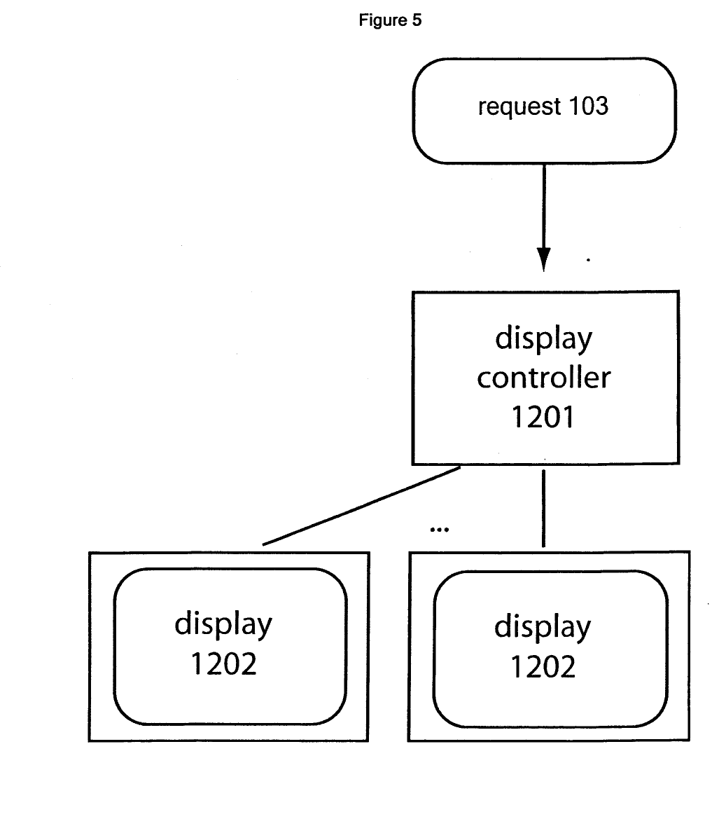

The artwork preparation subsystem 301 prepares customized versions of the artwork 102 included in the artwork deployment request 103 that are specifically adapted and suited to the characteristics of the requested displays. The artwork distribution subsystem 302 then sends the customized artwork to the remote sites 1102 through one or more signage commands 304. According to an embodiment of the present invention, the artwork distribution subsystem 302 is configured to query the communicatively connected electronic displays 105 for information, formats the information appropriately, and stores the status update 107 and/or presents it to the central user 101. Optionally, the remote site 1102 may include a store controller (not shown in FIG. 5) that serves as an intermediary between the central user 101 and some or all of the display controllers 1201 located at a remote site (e.g., a store or other shopping environment).

FIG. 5 depicts an exemplary schematic of a remote site 1102 of the signage environment 1, according to an embodiment of the present invention. As shown, the remote site 1102 may include a display controller 1201, a computer or computer-executable program or module configured to control the one or more displays 1202 located at the remote site 1102. The display controller 1201 may be any computer or device capable of supporting and/or maintaining one or more displays. While FIG. 5 depicts a plurality of displays 1102, one having ordinary skill in the art will appreciate that the display controller 1201 may control a single display 1202. As shown in FIG. 5, a request 103 (as processed by the signage management system 104) and/or one or more signage commands 304 (not shown) may be received and processed by the display controller 1201 to facilitate the distribution of the artwork to the appropriate display or displays 1202.

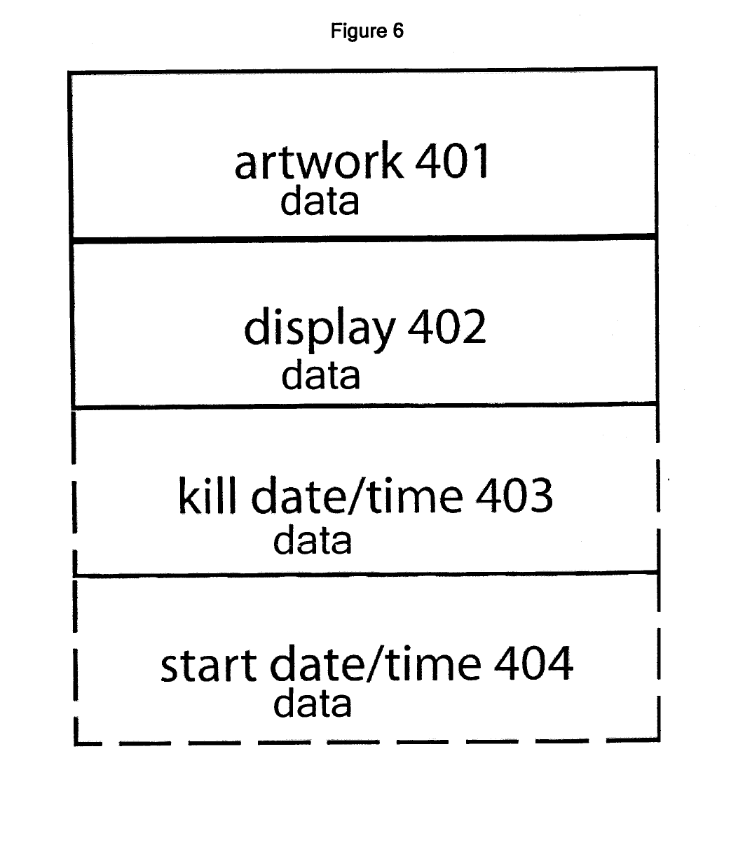

FIG. 6 illustrates an exemplary artwork deployment request 103. The artwork deployment request 103 may include, but is not limited to, the following data components or layers: 1) artwork data 401; 2) display data 402; 3) kill date/time data 403; and 4) start date/time data 404. The artwork data 401 includes data related to the artwork or content, and may be included directly or indirectly (such as by a reference to an existing file). The display data 402 may specify the one or more displays of the one or more remote sites to which the artwork is to be delivered and deployed.

Optionally, the artwork deployment request 103 may include kill date/time data 403, which tells the signage management system 104 when the artwork is to be removed from the display. Other optional data includes start date/time data 404, which is the first time at which the artwork is to be displayed. One having ordinary skill in the art will appreciate that while it is possible to implement start date/times at the remote site, it is generally more efficient to have the central site or signage management system 104 delay the transmission of the artwork deployment request or signage command 304 until the actual starting date and time.

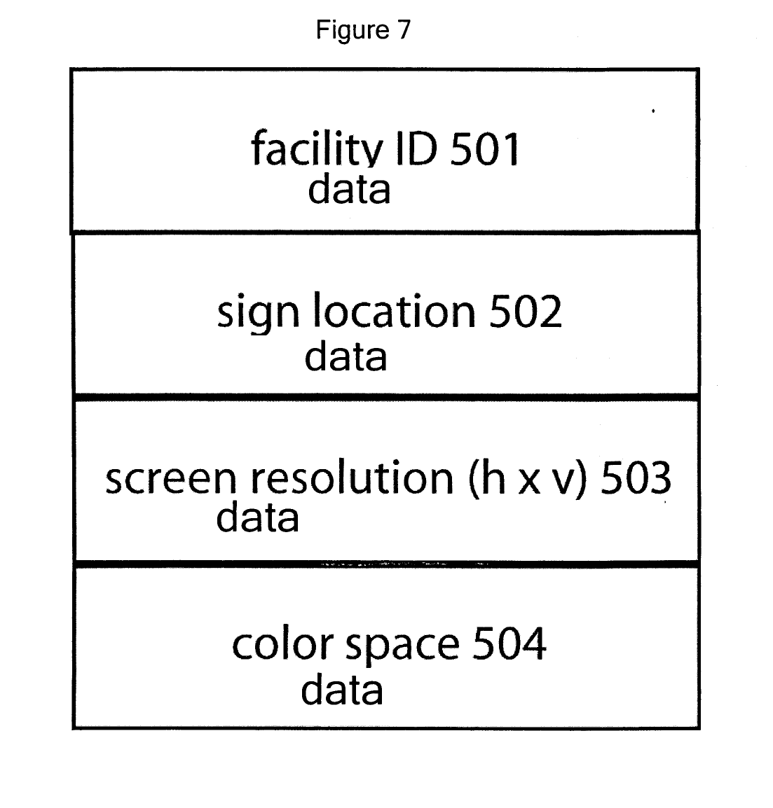

FIG. 7 shows one exemplary remote site record maintained by the remote site database 303. One having ordinary skill in the art will appreciate that other data organizations are possible. The facility ID data 501 describes the nature of the facility (e.g., store, hospital, etc.) at which the remote site is located. The sign location data 502 describes the location of the one or more electronic displays 105 and/or printed signs 106 in or at the facility. Another possible organization of the remote site record of the remote site database 303 includes a combination of the facility ID data 501 and the sign location data 502 into a single identifier or data component.

The remote site record may further comprise screen resolution data 503 providing the horizontal and vertical resolution of the one or more electronic displays 105. Color space data 504 may also be included which may be used for color management. In addition, if the remote site includes print signs 106, the remote site record may include information related to the hard-copy display, such as, for example, the dimensions of the display. Some paper signage may be put into locations that only display paper, while in other cases paper signage may be used to temporarily replace electronic displays, such as when the electronic display is broken or out of service.

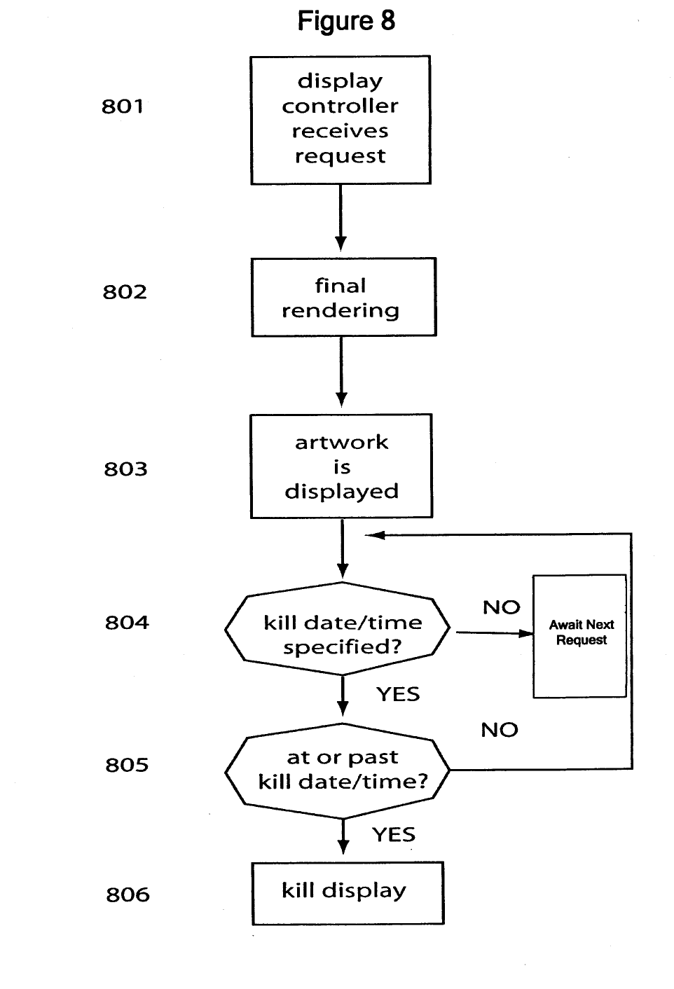

FIG. 8 show exemplary flowchart of the steps performed at a remote site 1102. The display controller 1201 receives an artwork deployment request 103, in step 801. The display controller 1201 performs any necessary ‘final’ rendering required, such as color space conversion or gamma adjustments, in step 802. The display controller 1201 then causes the artwork to be displayed on the requested display, in step 803. Optionally, the display controller 1201 may be configured to implement a kill date/time, depending on the instructions and data provided in the artwork deployment request. In step 804, the display controller 1201 may determine whether a kill date/time has been specified. If so, the display controller 1201 may compare the current date/time against the specified kill date/time. If the current date/time is at or past the kill date/time in step 805, then the display controller 1201 may cease display of the artwork, in step 806. If the artwork deployment request does not include a kill date/time, then the display controller 1201 waits for the next artwork deployment request.

FIG. 9 shows an exemplary method for processing of a customization request 110, according to an embodiment of the present invention. A remote user requests a customization in step 901, and submits the request to the signage management system 104 and/or the central user 101, in step 902. The customization request may then be approved, either automatically by the signage management system 104 or manually by the central user, in step 903. The signage management system 104 then checks whether a remote customizer (i.e., a computer-executed program configured to make customization to the artwork) is available at the remote site that can modify the artwork, in step 904. One having ordinary skill in the art will appreciate that it may be preferred to allows simple changes to be done remotely by the remote customizer, while more complicated or general changes may require more powerful programs that are preferably executed by the signage management system 104. If no remote customizer is available, the artwork preparation subsystem 301 customizes the artwork, in step 905, and the artwork distribution subsystem 302 sends the customized artwork to the remote site, in step 906.

If in step 904 it is determined that a remote customizer is available, the customization request 110 is sent to the remote customizer for performance of the customization, in step 908, which in turn sends the customized artwork to the remote site for display. Finally, the customized artwork is rendered and displayed by the appropriate display or displays of the remote site, in step 907. One having ordinary skill in the art will appreciate that some artwork formats, such as, for example, motion pictures, may need to be re-rendered due to, for example, bandwidth management, screen resolution, and frame rate, to name a few. Furthermore, audio data, which may be played to accompany the visual signage, may also need to be rendered or re-rendered to fit the characteristics, specifications, and/or limitations of the output or playback device of the display 1102.

It is to be understood that the exemplary embodiments are merely illustrative of the invention and that many variations of the above-described embodiments may be devised by one skilled in the art without departing from the scope of the invention. It is therefore intended that all such variations be included within the scope of the present invention.

What is claimed is:

1. A computerized method of managing remote displays, the method comprising the steps of:
receiving, from a central user, a deployment request to deploy artwork content in a first format on one or more displays;
querying a remote site database, based on the deployment request, for display requirement information of one or more displays;
generating from the artwork content, based on the display requirement information, customized artwork content in one or more second formats; and
displaying the customized artwork content on the displays.

2. The method of claim 1, further comprising the step of:
determining, based on the display requirement information, if an electronic display is available;
if an electronic display is available, transmitting the customized artwork content to the display; and
if an electronic display is not available, requesting the printing of a hardcopy display to display the customized artwork content.

3. The method of claim 1, wherein the deployment request comprises data related to:
the one or more displays at which the customized artwork content is to be displayed;
a permitted level of customization;
the format of the artwork content; and
a request for one or more reports related to the deployment request.

4. The method of claim 1, further comprising the step of:
receiving, from the one or more displays, status updates related to the state of the displays.

5. The method of claim 1, wherein the deployment request comprises:
data related to the artwork content;
data related to the one or more displays;
a display start time; and
a display end time.

6. The method of claim 1, wherein the display requirement information comprises:
facility ID data;
display location data;
display resolution data; and
color space data.

7. The method of claim 1, wherein the deployment request comprises:
a display start time; and
a display end time.

8. The method of claim 7, further comprising the steps of:
determining if the display end time has passed; and
if the display end time has passed, terminating display of the customized artwork content.

9. The method of claim 1, further comprising the steps of:
receiving, from a remote user, a display change request;
approving, by a central user, the display change request;
creating modified artwork content in the first format, based on the change request;
generating from the modified artwork content, based on the display requirement information, customized modified artwork content in one or more second formats; and
displaying the customized modified artwork content on the displays.

10. The method of claim 1, further comprising the steps of:
determining if a remote customizer is available; and
if a remote customizer is not available, generating the modified artwork content by a computerized artwork preparation system.

11. A computerized system for managing remote displays, the system comprising:
a computerized display management system configured to perform the steps of:
receiving, from a central user, a deployment request to deploy artwork content in a first format on one or more displays;
querying a remote site database, based on the deployment request, for display requirement information of one or more displays;
generating from the artwork content, based on the display requirement information, customized artwork content in one or more second formats; and
displaying the customized artwork content on the displays.

12. The system of claim 11, wherein the computerized display management system is further configured to perform the steps of:
determining, based on the display requirement information, if an electronic display is available;
if an electronic display is available, transmitting the customized artwork content to the display; and
if an electronic display is not available, requesting the printing of a hardcopy display to display the customized artwork content.

13. The system of claim 11, wherein the deployment request comprises data related to:
the one or more displays at which the customized artwork content is to be displayed;
a permitted level of customization;
the format of the artwork content; and
a request for one or more reports related to the deployment request.

14. The system of claim 11, wherein the computerized display management system is further configured to perform the steps of:
receiving, from the one or more displays, status updates related to the state of the displays.

15. The system of claim 11, wherein the deployment request comprises:
data related to the artwork content;
data related to the one or more displays;
a display start time; and
a display end time.

16. The system of claim 11, wherein the display requirement information comprises:
facility ID data;
display location data;
display resolution data; and
color space data.

17. The system of claim 11, wherein the deployment request comprises:
a display start time; and
a display end time.

18. The system of claim 17, wherein the computerized display management system is further configured to perform the steps of:
determining if the display end time has passed; and
if the display end time has passed, terminating display of the customized artwork content.

19. The system of claim 11, wherein the computerized display management system is further configured to perform the steps of:
receiving, from a remote user, a display change request;
approving, by a central user, the display change request;
creating modified artwork content in the first format, based on the change request;
generating from the modified artwork content, based on the display requirement information, customized modified artwork content in one or more second formats; and
displaying the customized modified artwork content on the displays.

20. The system of claim 11, wherein the computerized display management system is further configured to perform the steps of:
determining if a remote customizer is available; and
if a remote customizer is not available, generating the modified artwork content by a computerized artwork preparation system.
